(19) United States
(12) Patent Application Publication
(10) Pub. No.: US 2016/0062532 A1
(43) Pub. Date: Mar. 3, 2016

(54) SPECIFIED POSITION DETECTION DEVICE

(71) Applicant: NEWCOM TECHNO INC., Tokyo (JP)

(72) Inventors: Kenji TAHARA, Saitama (JP); Azuma MURAKAMI, Saitama (JP)

(21) Appl. No.: 14/430,493

(22) PCT Filed: Oct. 21, 2013
(86) PCT No.: PCT/JP2013/006215

§ 371 Date: Mar. 23, 2015

(51) Int. Cl. G06F 3/041; G06F 3/046

(52) U.S. Cl. CPC G06F 3/0416; G06F 3/046; G06F 3/0412

(57) ABSTRACT

To realize a specified position detection device that can easily detect a specified position with high accuracy. Based on a pulse drive resonance current that flows from a drive signal input unit 13 to Y-axis loop coils Y1, Y2, . . . , YM, a tuned resonance current flows through a position specifying tool 5 that is positioned adjacent to one Y-axis loop coil. Based on the tuned resonance current, an induced resonance current flows through one of X-axis loop coils X1, X2, . . . , XN where the position specifying tool 5 is positioned. As a result, a position detection output signal S6, which indicates a coordinate position where the position specifying tool 5 is positioned, is obtained. In this manner, by using a simple configuration that uses resonance operations of each component, from a specific positioned target coordinate position, it is possible to obtain a position detection signal that is clearly distinguishable from other coordinate positions.

### TECHNICAL FIELD

The present invention relates to a specified position detection device, and is suitably applied to an information processing device having a tablet display surface, for example.

### BACKGROUND ART

An information processing device having a tablet display surface is frequently used as a means to enable a user to specify a specific display position on the tablet display surface and easily carry out processing of information corresponding to the display position.

As for this kind of information processing device, as detection means for detecting a position specified by a user on the tablet display surface, what is proposed is a structure that detects, when a position specifying member containing a parallel resonance circuit, a magnetic substance, and the like is brought closer to a coordinate position on the display surface with a large number of loop coils provided in the display surface, the coordinate position as a position specified by the user (See Patent Documents 1 and 2).

### Prior Art Documents

### Patent Documents

### [Patent Document 1] Japanese Patent Application Laid-open Publication No. 7-44304

### [Patent Document 2] Japanese Patent Application Laid-open Publication No. 2010-85378

### SUMMARY OF THE INVENTION

### Problems to be Solved by the Invention

For the information processing device having the tablet display surface, using as simple a configuration as possible to detect a user's specified position on the display surface in such a way as to maintain as high a degree of detection accuracy as possible is effective as a means to increase the utility of the information processing device.

The present invention has been made in view of the above points, and is to provide a position detection device that has an even simpler configuration that enables exchange of a position detection signal between a loop coil and a position specifying member, with improved position detection accuracy.

### Means for Solving the Problems

To solve the above problems, according to the present invention, a specified position detection device that outputs, when a user specifies a coordinate position on an XY plane using a position specifying tool 5, a specified position detection signal indicating the specified position, is characterized by including:

a plurality of, or N, X-axis loop coils X1, X2, . . . , XN that are sequentially disposed in an X-axis direction on the XY plane and are made of a conductor extending in a Y direction; a plurality of, or M, Y-axis loop coils Y1, Y2, . . . , YM that are sequentially disposed in a Y-axis direction on the XY-plane in such a way as to cross the X-axis loop coils X1, X2, . . . , XN and are made of a conductor extending in an X direction; a drive signal input unit 13 that includes a plurality of drive input switches 21Y1, 21Y2, . . . , 21YM, which are each connected to one ends of the Y-axis loop coils Y1, Y2, . . . , YM and which generate magnetic fields by supplying a pulse drive resonance current into the connected Y-axis loop coils Y1, Y2, . . . , YM when being sequentially ON-operated; a position specifying tool 5 that supplies a tuned resonance current when having crossed magnetic fields generated from the Y-axis loop coils Y1, Y2, . . . , YM after a user puts the position specifying tool 5 at a position close to the X-axis loop coils X1, X2, . . . , XN and Y-axis loop coils Y1, Y2, . . . , YM. that are arranged in such a way as to cross each other on the XY plane; and a position detection signal output unit 14 that includes a plurality of position detection output switches 33X1, 33X2, . . . , 33XN, which are connected to one ends of the X-axis loop coils X1, X2, . . . , XN and which generate a detection output by supplying, to the X-axis loop coils X1, X2, . . . , XN, an induced resonance current induced by the tuned resonance current of the position specifying tool 5 when being sequentially ON-operated.

### Advantages of the Invention

According to the present invention, based on a pulse drive resonance current that flows from the drive signal input unit to the Y-axis loop coils, a tuned resonance current flows through the position specifying tool that is positioned adjacent to one Y-axis loop coil. Based on the tuned resonance current, an induced resonance current flows through one of the X-axis loop coils where the position specifying tool is positioned. As a result, a specified position detection output, which indicates a coordinate position where the position specifying tool is positioned, is obtained. In this manner, by using a simple configuration that uses resonance operations of each component, from a specific positioned target coordinate position, it is possible to obtain a position detection signal that is clearly distinguishable from other coordinate positions.

### BRIEF DESCRIPTION OF THE DRAWINGS

FIG. 1 is a schematic system diagram showing the overall configuration of an information processing device to which a position specified detection device of the present invention is applied.

FIG. 2 is a schematic connection diagram showing the detailed configuration of a specified position detection unit 4 of FIG. 1.

FIG. 3 is a signal waveform diagram showing a position detection operation of the specified position detection unit 4.

FIG. 4 is a signal waveform diagram showing a position detection operation of a specified position detection unit 4 according to a second embodiment.

### EMBODIMENTS FOR CARRYING OUT THE INVENTION

With reference to the accompanying drawings, an embodiment of the present invention will be described in detail.

(1) Overall Configuration of Information Processing Device

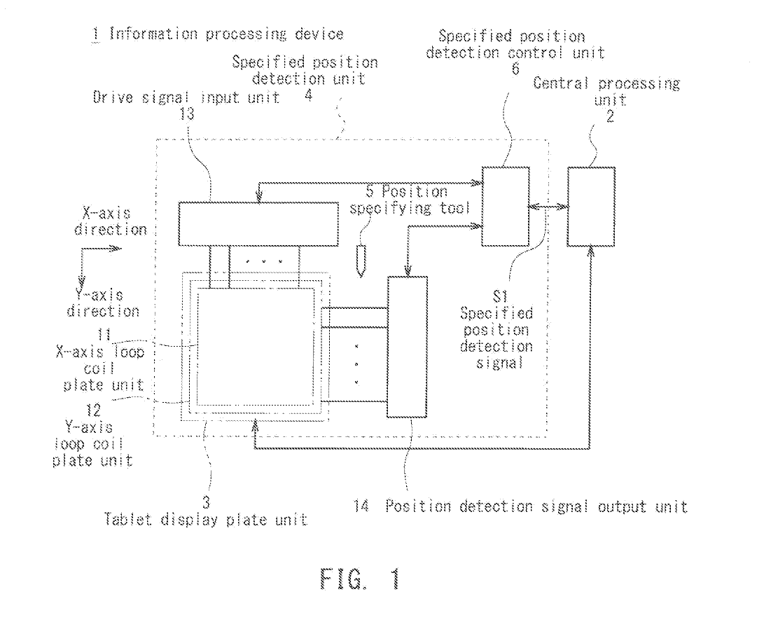

In FIG. 1, reference numeral 1 represents an information processing device of a first embodiment as a whole. A central processing unit 2 exchanges information with a tablet display plate unit 3. Therefore, in a specified position detection unit 4 that contains the tablet display plate unit 3, when a user specifies a specific position on an XY display surface of the tablet display plate unit 3 by using a position specifying tool 5, a specified position detection signal S1, which indicates the specified position, is output from a specified position detection control unit 6 to the central processing unit 2. The central processing unit 2 then carries out processing of corresponding information.

The tablet display plate unit 3 includes an X-axis loop coil plate unit 11 and a Y-axis loop coil plate unit 12; the X-axis loop coil plate unit 11 and the Y-axis loop coil plate unit 12 are disposed in such a way that their entire display surfaces overlap with each other. The Y-axis loop coil plate unit 12 is controlled by a drive signal input unit 13, which is controlled by the specified position detection control unit 6, to control inputting of signals in a Y-axis direction on the tablet display plate unit 3.

Moreover, the X-axis loop coil plate unit 11 is controlled by a detection signal output unit 14, which is controlled by the specified position detection control unit 6, to control detecting of position in an X-axis direction.

(2) Specified Position Detection Unit

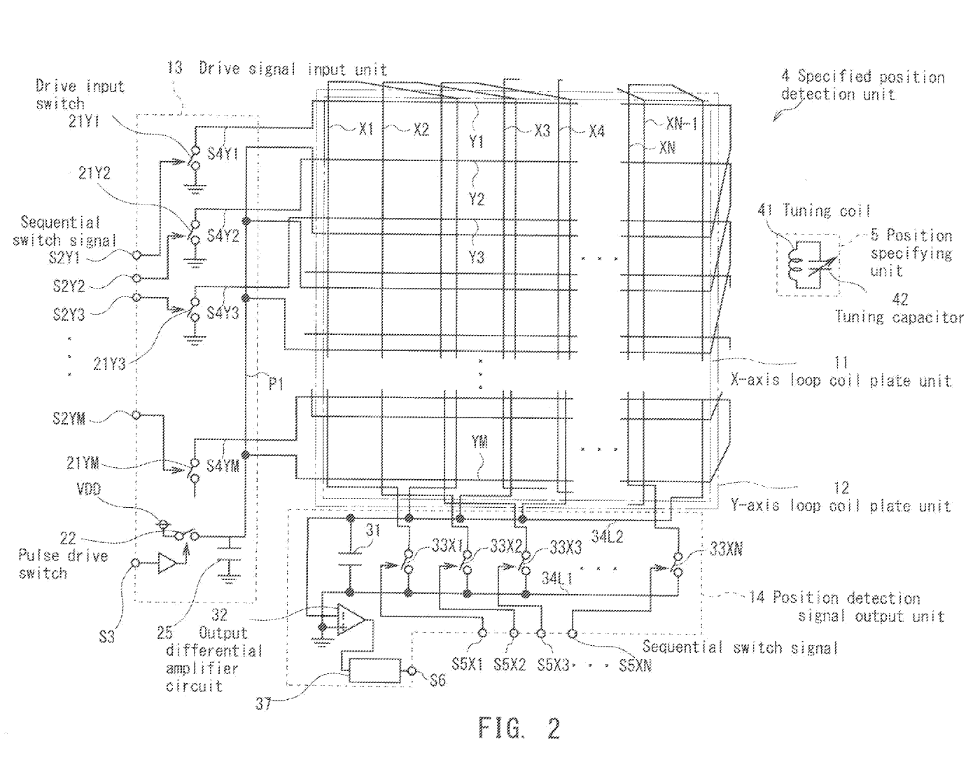

In the X-axis loop coil plate unit 11, as shown in FIG. 2, a plurality of, or N (e.g. 32) , X-axis loop coils X1, X2, . . . , XN are sequentially disposed in an X-axis direction (or horizontal direction in FIG. 2) , or in a horizontal direction, in such a way as to be longitudinally long and extend in a longitudinal direction as well as to be parallel to each other.

The X-axis loop coils X1, X2, . . . , XN each are a straight conductive wire that is wound once in such a way as to have a longitudinally long rectangular shape in the longitudinal direction. Therefore, at X-axis-direction center positions of the X-axis loop coils X1, X2, . . . , XN, N coordinate positions that are located at regular intervals in the X-axis direction on the XY display surface can be identified.

According to this embodiment, the positions of the X-axis loop coils X1, X2, . . . , XN are so determined that, in the X-axis direction, the adjacent X-axis loop coils partially overlap with one another in such a way as to spread in a width direction (or three X-axis loop coils that overlap with each other). To a position detection signal, X-axis-direction interpolation calculation is carried out, thereby improving the accuracy of detecting a specified position.

In the Y-axis loop coil plate unit 12, in FIG. 2, a plurality of, or M (e.g. 20) , Y-axis loop coils Y1, Y2, . . . , YM are sequentially disposed in the longitudinal direction, or in the Y-axis direction, in such a way as to be horizontally long and extend in a horizontal direction as well as to be parallel to each other.

The Y-axis loop coils Y1, Y2, . . . , YM each are a straight conductive wire that is wound once in such a way as to have a longitudinally long rectangular shape in the horizontal direction. Therefore, at Y-axis-direction center positions of the Y-axis loop coils Y1, Y2, . . . , YM, M coordinate positions that are located at regular intervals in the Y-axis direction on the XY display surface can be identified.

According to this embodiment, the positions of the Y-axis loop coils Y1, Y2, . . . , YM are so determined that, in the Y-axis direction, the adjacent Y-axis loop coils partially overlap with one another in such a way as to spread in a width direction (or three Y-axis loop coils that overlap with one another). To a position detection signal, Y-axis-direction interpolation calculation is carried out, thereby improving the accuracy of detecting a specified position.

Actually, the X-axis loop coil plate unit 11 and the Y-axis loop coil plate unit 12 are stacked in such a way that an insulating material layer is sandwiched therebetween. In this manner, the X-axis loop coils X1, X2, . . . , XN and the Y-axis loop coils Y1, Y2, . . . , YM are positioned in such a way as to be perpendicular to each other and in a grid pattern.

As a result, when a user specifies any XY coordinate position on the tablet display plate unit 3 using the position specifying tool 5, the coordinates of the specified position can be determined based on the positions where the X-loop coils X1, X2, . . . , XN are disposed in the X-axis direction and on the positions where the Y-axis loop coils Y1, Y2, . . . , YM are disposed in the Y-axis direction.

One ends of the Y-axis loop coils Y1, Y2, . . . , YM of the Y-axis loop coil plate unit 12 are connected to the ground via drive input switches 21Y1, 21Y2, . . . , 21YM, which are provided in the drive signal input unit 13.

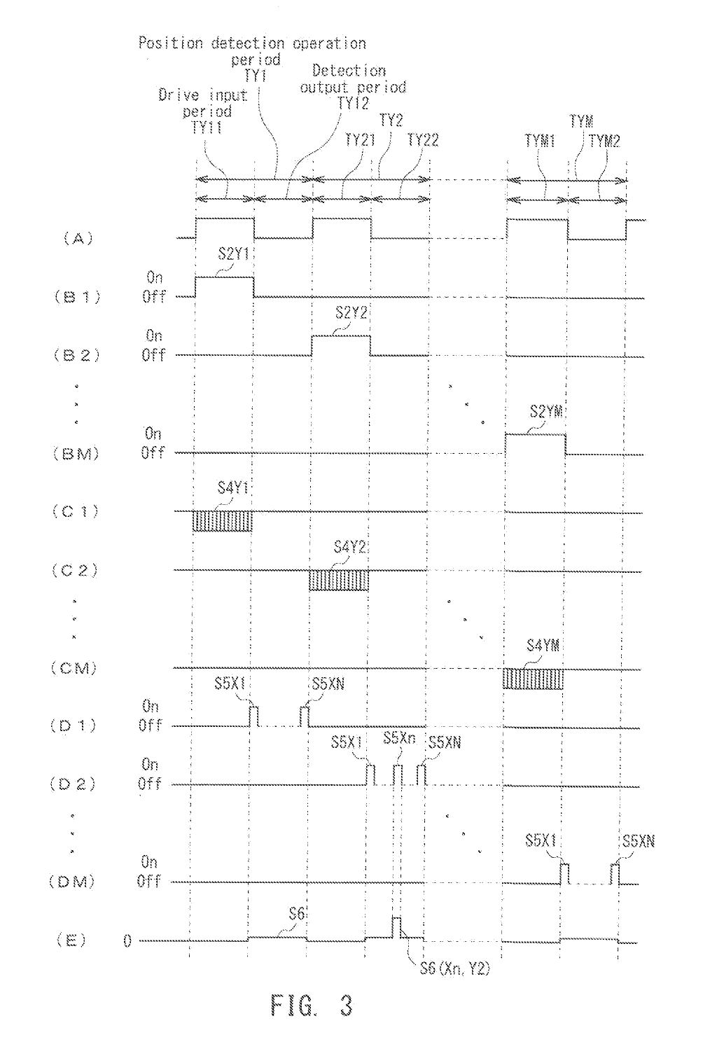

The drive input switches 21Y1, 21Y2, . . . , 21YM are controlled in such a way as to be turned ON or OFF at the timing shown in FIG. 3 (B1), (B2), . . . , (BM) in response to sequential switch signals S2Y1, S2Y2, . . . , S2YM given from the specified position detection control unit 6.

In the case of this embodiment, to the Y-axis loop coils Y1, Y2, . . . , YM, as shown in FIG. 3(A), position detection operation periods TY1, TY2, . . . , TYM of a predetermined duration are sequentially assigned. The first half of those periods are used as drive input periods TY11, TY21, . . . , TYM1, in which the sequential switch signals S2Y1, S2Y2, . . . , S2YM are activated to an ON-control level (FIG. 3 (B1), (B2), . . . , (BM)). Therefore, during the first-half periods, to the Y-axis loop coils Y1, Y2, . . . , YM, drive pulse signals S4Y1, S4Y2, . . . , S4YM are supplied (FIG. 3 (C1), (C2), . . . , (CM)).

One ends of the Y-axis loop coils Y1, Y2, . . . , YM are connected to a power supply terminal to receive power VDD from the specified position detection control unit 6 via a pulse drive switch 22, which is provided in the drive signal input unit 13.

The pulse drive switch 22 is controlled in such a way as to be turned ON or OFF at predetermined pulse intervals in response to a pulse control signal S3 supplied from the specified position detection control unit 6. Therefore, as shown in FIG. 3 (B1), (B2), . . . , (BM), as the drive input switches 11Y1, 11Y2, . . . , 11YM are controlled by the drive input signals S2Y1, S2Y2, . . . , S2YM in such a way as to be turned ON, the drive pulse signals S4Y1, S4Y2, . . . , S4YM are sequentially supplied to the Y-axis loop coils Y1, Y2, . . . , YM. via a common connection point P1 at the timing shown in FIG. 3 (C1), (C2), . . . , (CM).

The common connection point P1 for the pulse drive switch 22 and the Y-axis loop coils Y1, Y2, . . . , YM is grounded via a input-side resonance capacitor 25. Therefore, when the drive pulse signals S4Y1, S4Y2, . . . , S4YM are supplied to the Y-axis loop coils Y1, Y2, . . . , YM, the Y-axis loop coils Y1, Y2, . . . , YM each form a parallel resonance circuit along with the input-side resonance capacitor 25.

In the case of this embodiment, to the Y-axis loop coils Y1, Y2, . . . , YM, as shown in FIG. 3(A), position detection operation periods TY1, TY2, . . . , TYM of a predetermined duration are sequentially assigned. The first half of those periods are used as drive input periods TY11, TY21, . . . , TYM1, in which the sequential switch signals S2Y1, S2Y2, . . . , S2YM are activated to an ON-control level (FIG. 3 (B1), (B2), . . . , (BM)). Therefore, during the first-half periods, to the Y-axis loop coils Y1, Y2, . . . , YM, drive pulse signals S4Y1, S4Y2, . . . , S4YM. are supplied (FIG. 3 (C1), (C2), . . . , (CM)).

The resonance frequency of the parallel resonance circuits, which are formed by the Y-axis loop coils Y1, Y2, . . . , YM and the input-side resonance capacitor 25, is set to an ON/OFF frequency of the power VDD that is supplied via the pulse drive switch 22. Therefore, when each of the Y-axis loop coils Y1, Y2, . . . , YM forms each parallel resonance circuit, a large current can flow therethrough. Thus, during the drive input periods TY11, TY12, . . . , TYM2, or first-half portions of the position detection operation periods TY1, TY2, . . . , TYM, the Y-axis loop coils Y1, Y2, . . . , YM can generate strong drive magnetic fields.

One ends of the X-axis loop coils X1, X2, . . . , XN of the X-axis loop coil plate unit 11 are connected to a non-inverting input terminal of an output differential amplifier circuit 32 through position detection output switches 33X1, 33X2, . . . , 33XN, which are provided in the position detection signal output unit 14 in such a way as to correspond to the X-axis loop coils X1, X2, . . . , XN, and then through a common connection line 34L1. The other ends of the X-axis loop coils X1, X2, . . . , XN are connected in common to each other, and are connected to an inverting input terminal of the output differential amplifier circuit 32 via a common connection line 34L2.

To the position detection output switches 33X1, 33X2, . . . , 33XN, sequential switch signals S5X1, S5X2, . . . , S5XN are supplied from the specified position detection control unit 6. As shown in FIG. 3 (D1), (D2), . . . , (DM), during the detection output periods TY12, TY22, . . . , TYM2, or the last-half portions of the position detection operation periods TY1, TY2, . . . , TYM, as ON-operations are sequentially carried out, induced voltages generated at the X-axis loop coils X1, X2, . . . , XN are input between the non-inverting input terminal and inverting input terminal of the output differential amplifier circuit 32 via the position detection output switches 33X1, 33X2, . . . , 33XN.

In the case of the present embodiment, between the common connection lines 34L1 and 34L2 of the one and other ends of the X-axis loop coils X1, X2, . . . , XN, an output-side resonance capacitor 31 is connected. Therefore, as the X-axis loop coils X1, X2, . . . , XN are sequentially ON-operated, parallel resonance circuits are sequentially formed by the X-axis loop coils X1, X2, . . . , XN and the output-side resonance capacitor 31. At this time, an induced resonance voltage generated at both ends of the output-side resonance capacitor 31 is given to the non-inverting input terminal and inverting input terminal of the output differential amplifier circuit 32 as a position detection output.

The position specifying tool 5 includes a resonance loop, which has a tuning coil 41 and a tuning capacitor 42. As described above with reference to FIG. 3, during the position detection operation periods TY1, TY2, . . . , TYM, provided for the Y-axis loop coils Y1, Y2, . . . , YM, as the drive inputs S2Y1, S2Y2, . . . , S2YM are supplied during the drive input periods TY11, TY21, . . . , TYM1, and as a resonance current flows through the Y-axis loop coils Y1, Y2, . . . , YM, magnetic fields are generated. At this time, a tuned resonance current that is tuned to the magnetic fields flows through the tuning coil 41 and the tuning capacitor 42, leading to accumulation of a tuned resonance energy.

In the case of the present embodiment, a tuning frequency of the tuning coil 41 and the tuning capacitor 42 is set to a value that matches a resonance frequency of a resonance current of the Y-axis loop coils Y1, Y2, . . . , YM, enabling efficient accumulation of the resonance energy of the resonance current of the Y-axis loop coils Y1, Y2, . . . , YM in the tuning resonance loop.

Therefore, through the tuning coil 41 and the tuning capacitor 42, a tuned resonance current of a resonance frequency that is determined by the tuning coil 41 and the tuning capacitor 42 continues flowing during the detection output periods TY12, TY22, . . . , TYM2, which follow the drive input periods TY11, TY21, . . . , TYM1, thereby inducing an induced electromotive force on the X-axis loop coils X1, X2, . . . , XN based on the tuned resonance current.

As for the induced current that is induced on the X-axis loop coils X1, X2, . . . , XN, as described above in FIG. 3 (D1), (D2), . . . , (DM), during each of the detection output periods TY12, TY22, . . . , TYM2, when the position detection output switches 33X1, 33X2, . . . , 33XN are ON-operated, the induced current carries out a resonance operation together with the output-side resonance capacitor 31.

As a result, a resonance voltage that is obtained at both ends of the output-side resonance capacitor 31 is sequentially transmitted as a position detection output signal S6 via the output differential amplifier circuit 32 and then via a synchronous detection circuit 37.

(3) Specified Position Detection Operation

In the above configuration, when a user specifies a position by moving the position specifying tool 5 toward, for example, coordinate position (Xn, Y2) among XY coordinates on the X-axis loop coil plate unit 11 and Y-axis loop coil plate unit 12 of the tablet display plate unit 3, for the Y-axis loop coil plate unit 12, the specified position detection control unit 6 performs an ON-operation of the drive input switch 21Y2 using a sequential switch signal S2Y2 of the drive signal input unit 13, and also performs a pulse output drive operation of the pulse drive switch 22. As a result, during the drive input period TY21, or a first-half portion of the position detection operation period TY2 of FIG. 3, a resonance input current flows through the Y-axis loop coil Y2 because of the Y-axis loop coil Y2 and the input-side resonance capacitor 25.

At this time, the position specifying tool 5 is located at a position close to the Y-axis loop coil Yn. As a result, the tuning coil 41 is electromagnetically coupled with magnetic fields generated by a drive resonance current that flows through the Y-axis loop coil Y2, thereby providing drive-input energy to the position specifying tool 5.

In this state, as shown in FIG. 3 (D2) , during the detection output period TY22 of the position detection operation period TY2 of the Y-axis loop coil Y2, the position detection signal output unit 14 sequentially starts ON-operations of the position detection output switches 33X1, 33X2, . . . , 33Xn, . . . , 33XN using the sequential switch signals S5X1, S5X2, . . . , S5Xn, . . . , S5XN.

At this time, the tuning coil 41 of the position specifying tool 5 works to generate a tuned resonance current on the X-axis loop coil Xn, which is specified by the user. However, since the other X-axis loop coils X1, X2, . . . , Xn−1, Xn+1, . . . , XN are not located adjacent to the position specifying tool 5, a tuned resonance current is unlikely to be generated at the X-axis loop coils other than X-axis loop coil Xn.

When the position detection output switch 33Xn of the position detection signal output unit 14 is turned ON, an induced current that is induced on the X-axis loop coil Xn helps to keep the situation where an induced resonance current flows due to the output-side resonance capacitor 31.

At both ends of the output-side resonance capacitor 31 of the position detection signal output unit 14, a large induced resonance voltage is formed due to the resonance operation. The voltage is transmitted as a position detection output signal S6 via the output differential amplifier circuit 32 and the synchronous detection circuit 37.

When the other position detection output switches 33X1, 33X3, . . . , 33XN except the position detection output switch 33Xn are ON-operated, induced resonance voltages are generated on corresponding X-axis loop coils X1, X3, . . . , XN based on resonance currents of the tuning coil 41 and tuning capacitor 42 of the position specifying tool 5; the values of the induced resonance voltages are not greater than the voltage of the inverting input terminal. Therefore, a voltage level of the output terminal of the output differential amplifier circuit 32 becomes smaller.

Moreover, even if a resonance current from the input-side resonance capacitor 25 flows through the Y-axis loop coils Y1, Y3, . . . , YM except the one at coordinates (Xn, Y2) specified by the position specifying tool 5 as the drive input switches 21Y1, 21Y2, . . . , 21YM are ON-operated, the position specifying tool 5 is not located adjacent to the Y-axis loop coils Y1, Y3, . . . , YM, and therefore the tuning coil 41 of the position specifying tool 5 cannot carry out a tuning operation, thereby not leading to the situation where a sufficient value of tuned resonance current flows through the tuning coil 41 and the tuning capacitor 42.

In that manner, even if the Y-axis loop coils Y1, Y3, . . . , YM form the resonance circuits with the output-side resonance capacitor 31 as the position detection output switches 33X1, 33X3, . . . , 33XN are ON-operated, a sufficiently large induced resonance current does not flow from the tuning coil 41 and tuning capacitor 42 of the position specifying tool 5 into the parallel resonance circuits that are formed between the X-axis loop coils X1, X3, . . . , XN and the output-side resonance capacitor 31. Therefore, in effect, from the output differential amplifier circuit 32, a detection output cannot be obtained.

As a result, from the position detection signal output unit 14, as shown in FIG. 3 (E) , as for the X-axis loop coil Xn that is interlinked with the Y-axis loop coil Y2 in such a way as to correspond to the coordinates (Xn, Y2) specified by the position specifying tool 5, during the detection output period TY22, position detection output signal S6 (Xn, Y2) is output at the timing when the X-axis loop coil Xn is ON-operated.

As for the detection outputs that are obtained from the X-axis loop coils X1, X2, . . . , XN and obtained in the output differential amplifier circuit 32, a plurality of detection outputs are obtained from a plurality of X-axis loop coils near a specified position depending on the deviation of the X-axis loop coils X1, X2, . . . , XN and Y-axis loop coils Y1, Y2, . . . , YM from a central position of the specified position within the width. Accordingly, a coordinate position interpolation means provided in the central processing unit 2 carries out an interpolation operation from the detection outputs to calculate a specified position detection signal corresponding to the specified position.

According to the above configuration, when a user specifies a coordinate position on the tablet display plate unit 3 using the position specifying tool 5, tuning energy is supplied from the drive signal input unit 13 to the tuning coil 41 and tuning capacitor 42 of the position specifying tool 5 located at the specified position, thereby inducing an tuned resonance current on the X-axis loop coil Xn connected to the position detection signal output unit 14 from the position specifying tool 5. As a result, a detection output that indicates the coordinate position (Xn, Y2) specified by the position specifying tool 5 can be obtained.

In that manner, as the resonance current flows from the input-side resonance capacitor 25 of the input-side Y-axis loop coils Y1, Y2, . . . , Yn, . . . , YM, large energy can be given to the position specifying tool 5 with simple configuration. As a result, a tuning resonance operation can be performed. Moreover, due to the tuning resonance operation of the position specifying tool 5, the output X-axis loop coils X1, X2, . . . , XN carry out an induced resonance operation together with the output-side resonance capacitor 31, thereby making sure to obtain a large value of the detection output corresponding to the coordinate position (Xn, Y2) where the tool is positioned.

In that manner, the configuration is relatively simple as a whole, and this configuration makes it possible to obtain the position detection output signal S6 indicating the coordinate position (Xn, Y2), which is specified by the position specifying tool 5, with high accuracy.

(4) Second Embodiment

According to the above-described first embodiment, the position detection signal output unit 14 supplies the drive pulse signals S4Y1, S4Y2, . . . , S4YM to the Y-axis loop coils Y1, Y2, . . . , YM during the drive input periods TY11, TY12, . . . , TYM1 or the first-half portions of the position detection operation periods TY1, TY2, . . . , TYM of FIG. 3 (FIG. 3(C1), (C2), . . . , (CM)). Then, during the detection output periods TY12, Y22, . . . , TYM2 that follow, or the second-half portions of the periods, the position detection signal output unit 14 supplies the sequential switch signals S5X1, S5X2, . . . , S5XN for the X-axis loop coils X1, X2, . . . , XN. In this manner, the position detection signal output unit 14 obtains the position detection output signal S6.

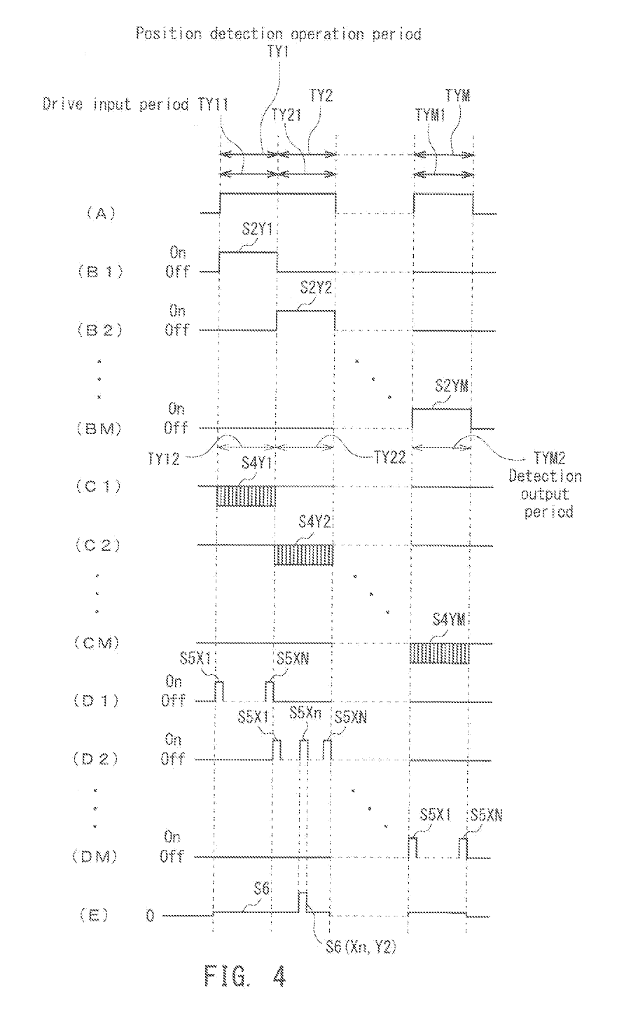

According to a second embodiment, as shown in FIG. 4, the drive signal input unit 13 regards the position detection operation periods TY1, TY2, . . . , TYM as the drive input periods TY11, TY21, . . . , TYM1 (FIG. 4 (B1), (B2), . . . , (BM)) to input the drive pulse signals S4Y1, S4Y2, . . . , S4YM (FIG. 4 (C1) , (C2) , . . . , (CM)) to the Y-axis loop coils Y1, Y2, . . . , YM. Meanwhile, the position detection signal output unit 14 regards the position detection operation periods TY1, TY2, . . . , TYM as the detection output periods TY12, TY22, . . . , TYM2 to supply the sequential switch signals S5X1, S5X2, . . . , S5XN to the position detection output switches 33X1, 33X2, . . . , 33XN (FIG. 4 (D1), (D2), . . . , (DM)).

According to the above configuration, through the Y-axis loop coils Y1, Y2, . . . , YM, the drive pulse signals S4Y1, S4Y2, . . . , S4YM flow. Therefore, in the situation where a tuned resonance current is occurring at the tuning coil 41 and tuning capacitor 42 of the position specifying tool 5, the corresponding position detection output signal S6 is simultaneously obtained from the X-axis loop coil X1, X2, . . . , XN which the position specifying tool 5 is approaching (FIG. 4(E)).

In that manner, at almost the same time when the drive input signal is given to the Y-axis loop coils Y1, Y2, . . . , YM, the position detection output can be obtained from the X-axis loop coils X1, X2, . . . , XN. Therefore, it is possible to realize a specified position detection device that can shorten the position detection operation time as a whole.

In the case of the present embodiment, the position detection operation is executed at the same time when the drive input signal is given. Even though the position detection output contains noise components based on the drive input signal, the noise components are removed by noise removal means provided in the output differential amplifier circuit 32 and the synchronous detection circuit 37.

(5) Other Embodiments

(5-1) According to the first embodiment, in the X-axis direction and the Y-axis direction, the X-axis loop coils X1, X2, . . . , XN and the Y-axis loop coils Y1, Y2, . . . , YM are spread in such a way that the three X-axis loop coils and the three Y-axis loop coils overlap with one another. However, the number of coils that overlap with one another may be three or more, or zero (i.e. the coils are not spread in such a way as to overlap with one another). Even in such a case, the same advantageous effects as those described above can be achieved.

(5-2) According to the first embodiment, as the X-axis loop coils X1, X2, . . . , XN and the Y-axis loop coils Y1, Y2, . . . , YM, a conductive linear body that is wound twice into a longitudinally long shape is used. However, as a conductive material, a strip-shaped or plate-like one may be used. The number of turns may be one, or three or more.

(5-3) According to the above embodiments, the number of X-axis loop coils X1, X2, . . . , XN is set to N=32, and the number of Y-axis loop coils Y1, Y2, . . . , YM is set to M=20. However, those numbers may be arbitrarily set when necessary.

(5-4) According to the above embodiments, as for the configuration of the tablet display plate unit 3, the X-axis loop coil plate unit 11 and the Y-axis loop coil plate unit 12 are stacked in such a way that an insulating material layer is sandwiched therebetween. However, the present invention is not limited to this configuration, and various kinds of configuration may be employed as long as a coordinate position can be determined when the position specifying tool 5 is approaching.

(5-5) In the above embodiments, each of the switch sections may be a semiconductor switch circuit, for example. More specifically, MOSFET (Metal-Oxide-Semiconductor Field-Effect Transistor), IGBT (Insulated Gate Bipolar Transistor), analog switches, transistors, and the like are available.

### INDUSTRIAL APPLICABILITY

The present invention can be used to obtain position information of a position specified through an operation panel display surface.

### EXPLANATION OF REFERENCE SYMBOLS

1: Information processing device

2: Central processing unit

3: Tablet display plate unit

4: Specified position detection unit

5: Position specifying tool

6: Specified position detection control unit

11: X-axis loop coil plate unit

12: Y-axis loop coil plate unit

13: Drive signal input unit

14: Position detection signal output unit

21Y1 to 21YM: Drive input switch

22: Pulse drive switch

25: Input-side resonance capacitor

31: Output-side resonance capacitor

32: Output differential amplifier circuit

33X1 to 33XN: Position detection output switch

37: Synchronous detection circuit

41: Tuning coil

42: Tuning capacitor

X1 to XN: X-axis loop coil

Y1 to YM: Y-axis loop coil

1. A specified position detection device that outputs, when a user specifies a coordinate position on an XY plane using a position specifying tool, a specified position detection signal indicating the specified position, characterized by comprising:
a plurality of, or N, X-axis loop coils that are sequentially disposed in an X-axis direction on the XY plane and are made of a conductor extending in a Y-axis direction; a plurality of, or M, Y-axis loop coils that are sequentially disposed in a Y-axis direction on the XY-plane in such a way as to cross the X-axis loop coils and are made of a conductor extending in the X direction;
a drive signal input unit that generates magnetic fields when a plurality of drive input switches, connected to one ends of the plurality of Y-axis loop coils are sequentially ON-operated, by supplying a pulse drive resonance current to the connected Y-axis loop coil from a pulse drive switch connected in common to the other end of the Y-axis loop coil;
a position specifying tool that includes a tuning resonance circuit that holds a tuned resonance current when having crossed magnetic fields generated from the Y-axis loop coils after a user puts the position specifying tool at a position close to the X-axis loop coils and Y-axis loop coils that are arranged in such a way as to cross each other on the XY plane; and
a position detection signal output unit that generates a detection output, which indicates the specified position, via a common connection line connected in common to the other ends of the X-axis loop coils by supplying, to the X-axis loop coils, an induced resonance current induced by the tuned resonance current held by the tuning resonance circuit of the position specifying tool, when a plurality of position detection output switches connected to one ends of the plurality of X-axis loop coils are sequentially ON-operated.

2. The specified position detection device according to claim 1, characterized in that
the drive signal input unit connects an input-side parallel resonance capacitor to generates the pulse drive switches connected in common to the other ends of the plurality of Y-axis loop coils to allow, based on a pulse drive current that flows through the Y-axis loop coil via one of the drive input switches ON-operated, the one Y-axis loop coil and the input-side parallel resonance capacitor to resonate, thereby generating the pulse drive resonance current.

3. The specified position detection device according to claim 1, characterized in that
the position detection signal output unit connects an output-side parallel resonance capacitor to the common connection line connected in common to the other ends of the plurality of X-axis loop coils to allow, based on an induced current induced on the X-axis loop coil via one of the position detection output switches ON-operated, the one X-axis loop coil and the output-side parallel resonance capacitor to resonate, thereby making the induced resonance current.

4. The specified position detection device according to claim 3, characterized in that
the position detection signal output unit inputs a voltage across the output-side parallel resonance capacitor to a non-inverting input terminal and inverting input terminal of an output differential amplifier circuit, which is a differential amplifier, thereby outputting, at an output terminal of the output differential amplifier circuit, a detection output indicating the specified position.

5. The specified position detection device according to claim 1, characterized in that
a resonance frequency of a pulse drive resonance current of the drive signal input unit, a resonance frequency of a tuned resonance current of the position specifying tool, and a resonance frequency of an induced resonance current of the position detection signal output unit are set to the same frequency.

6. The specified position detection device according to claim 1, characterized in that:
the drive signal input unit assigns a sequential position detection operation period to the plurality of Y-axis loop coils, and uses a first-half portion of the sequential position detection operation period as a drive input period to supply a drive input signal to the plurality of Y-axis loop coils; and the position detection signal output unit uses a second-half portion of the sequential position detection operation period as a detection output period to sequentially output a detection output on the basis of an induced resonance current induced sequentially from the plurality of X-axis loop coils.

7. The specified position detection device according to claim 1, characterized in that:
the drive signal input unit assigns a sequential position detection operation period to the plurality of Y-axis loop coils, and uses the sequential position detection operation period as a drive input period to supply a drive input signal to the plurality of Y-axis loop coils; and the position detection signal output unit uses the sequential position detection operation period as a detection output period to sequentially output a detection output on the basis of an induced resonance current induced sequentially from the plurality of X-axis loop coils.
